(19) United States
(12) Patent Application Publication
(10) Pub. No.: US 2025/0253585 A1
(43) Pub. Date: Aug. 7, 2025

(54) ELECTRICAL CONNECTOR

(71) Applicant: LOTES CO., LTD., Keelung (TW)

(72) Inventors: Po-Jui Chou, Keelung (TW); Zhi-Guo Peng, Keelung (TW); Wen-Chang Chang, Keelung (TW); Chi-Chang Lin, Keelung (TW); Qui-Shen Feng, Keelung (TW); Xing-Jian Mo, Keelung (TW)

(21) Appl. No.: 19/021,608

(22) Filed: Jan. 15, 2025

(30) Foreign Application Priority Data
Feb. 3, 2024 (CN) 202410152642.7

(51) Int. Cl. H01R 13/6471; H01R 13/405; H01R 13/502; H01R 13/516

(52) U.S. Cl. CPC H01R 13/6471; H01R 13/405; H01R 13/502; H01R 13/516

(57) ABSTRACT

An electrical connector includes signal terminals and ground terminals, and a lossy member. The signal terminals and the ground terminals are arranged along a left-right direction. Along a vertical direction, a projection of at least one ground terminal and a projection of the lossy member overlap with each other. At least one ground terminal integrally extends toward the lossy member to form a side plate. Along the left-right direction, a projection of the side plate and the projection of the lossy member overlap with each other, such that a portion of a noise is attenuated, but the other portion of the noise radiates outward. At least one ground terminal and the side plate provide the shielding functions around the lossy member, such that the other portion of the noise radiated outward is shielded by the side plate, thereby reducing the impact of the noise.

### CROSS-REFERENCE TO RELATED PATENT APPLICATION

This non-provisional application claims priority to and the benefit of, pursuant to 35 U.S.C. § 119(a), patent application Serial No. CN202410152642.7 filed in China on Feb. 3, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector capable of reducing crosstalk.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A conventional electrical connector includes an insulating body, a terminal assembly and a conductive shielding sheet. The insulating body accommodates the terminal assembly and the conductive shielding sheet. The terminal assembly includes terminals in an upper row and a lower row. The conductive shielding sheet is located between the terminals in the upper row and the lower row, and the conductive shielding sheet is formed by embedding multiple conductive plastic strips in a metal sheet. The conductive plastic strips are respectively in contact with the ground terminals in the terminal assembly to reduce the crosstalk. However, the inventors found that, while the contact between the conductive plastic strips and the ground terminals may reduce the far-end crosstalk of the signals in the high frequency band, it cannot reduce the far-end crosstalk of the signals in the mid-to-low frequency band and may even increase the far-end crosstalk of the signals in the mid-to-low frequency band. Therefore, merely providing conductive plastic strips is far from sufficient to reduce the overall far-end crosstalk.

Therefore, a heretofore unaddressed need to design a new electrical connector exists in the art to address the aforementioned deficiencies and inadequacies.

### SUMMARY

The present invention is directed to an electrical connector, in which a side plate shields the interference signal radiated outward by the adjacent signal terminal. Along a vertical direction, a projection of each ground terminal and a projection of the lossy member overlap with each other, and along the left-right direction, a projection of the side plate and the projection of the lossy member overlap with each other, such that a portion of a noise is transmitted to the lossy member and is attenuated. The other portion of the noise scattered outward is shielded by the side plate, thereby reducing the far-end crosstalk.

To achieve the foregoing objective, the present invention adopts the following technical solutions:

An electrical connector includes: an insulating body; a plurality of signal terminals and a plurality of ground terminals, arranged along a left-right direction and accommodated in the insulating body; and a lossy member, wherein along a vertical direction, a projection of at least one of the ground terminals and a projection of the lossy member overlap with each other; wherein at least one of the ground terminals integrally extends toward the lossy member to form at least one side plate, and along the left-right direction, a projection of the side plate and the projection of the lossy member overlap with each other.

In certain embodiments, at least one of the ground terminals integrally extends toward the lossy member to form two side plates, and the two side plates are respectively located at a left side and a right side of the lossy member and are respectively in contact with the lossy member.

In certain embodiments, the electrical connector further includes a shielding member accommodated in the insulating body, wherein: along the vertical direction, the lossy member is located between the ground terminals and the shielding member; and at least one of the ground terminals integrally extends toward the lossy member to form two side plates, and the two side plates are respectively located at a left side and a right side of the lossy member and are respectively in contact with the lossy member, and the two side plates are respectively in contact with the shielding member.

In certain embodiments, the electrical connector further includes a shielding member accommodated in the insulating body, wherein: along the vertical direction, the lossy member is located between the ground terminals and the shielding member, a gap exists between the lossy member and at least one of the ground terminals, and the side plate is in contact with the shielding member; and along the left-right direction, the side plate is in contact with the lossy member.

In certain embodiments, along a front-rear direction, an insulating member is provided in front of the lossy member; along the vertical direction, the insulating member is located between the shielding member and the ground terminals, and the insulating member abuts against the ground terminals; and along the left-right direction, a projection of the insulating member and the projection of the side plate at least partially overlap with each other.

In certain embodiments, the electrical connector further includes a shielding member accommodated in the insulating body, wherein: in the vertical direction, the lossy member is located between the ground terminals and the shielding member, and at least one of the ground terminals is in contact with the lossy member; and in the left-right direction, the side plate is in contact with the lossy member.

In certain embodiments, in a front-rear direction, a front end surface of the side plate passes forward beyond a front end surface of the lossy member, the front end surface of the lossy member passes forward beyond a front end surface of each of the signal terminals or is flush with the front end surface of each of the signal terminals, and a rear end surface of the side plate passes backward beyond a rear end surface of the lossy member.

In certain embodiments, in a front-rear direction, a front end surface of the lossy member is located between a front end surface of each of the signal terminals and a front end surface of the side plate.

In certain embodiments, the electrical connector further includes a shielding member accommodated in the insulating body, wherein: along the vertical direction, the lossy member is located between the ground terminals and the shielding member, the lossy member comprises a first portion in contact with the shielding member and a second portion connected to the first portion, and the first portion is located between the second portion and the shielding member; and along the left-right direction, the first portion is in contact with the side plate, and the second portion is not in contact with the side plate.

In certain embodiments, the second portion comprises a first surface and at least one second surface connected to the first surface; along the vertical direction, a first gap exists between the first surface and at least one of the ground terminals, along the left-right direction, a second gap exists between the second surface and at least one of the ground terminals, the first gap is in communication with the second gap, and air is respectively filled in the first gap and the second gap; and along the vertical direction, a width of the second gap becomes narrower in a direction from the second portion toward the first portion.

In certain embodiments, the electrical connector further includes a shielding member and at least two insulating blocks accommodated in the insulating body, wherein: each of the insulating blocks has at least one of the signal terminals therein; at least one of the ground terminals extends toward the lossy member to form two side plates, and the two side plates are respectively located at a left side and a right side of the lossy member and are respectively in contact with the lossy member; viewing along a front-rear direction, the lossy member is located between the two insulating blocks; along the vertical direction, the lossy member is located between at least one of the ground terminals and the shielding member, a gap exists between each of the ground terminals and the lossy member, and each of the insulating blocks comprises a first end in contact with the signal terminals and a second end in contact with the shielding member; and along the left-right direction, a first distance exists between two adjacent first ends, a second distance exists between two adjacent second ends, and the first distance is greater than the second distance.

In certain embodiments, the electrical connector further includes a shielding member accommodated in the insulating body, wherein: along the vertical direction, the lossy member is located between the ground terminals and the shielding member, the lossy member comprises a first portion in contact with the shielding member and a second portion connected to the first portion, and the first portion is located between the second portion and the shielding member; and along the left-right direction, the first portion is in contact with the side plate, along the vertical direction, the second portion is in contact with the ground terminals, and a slot exists between the second portion and at least one of the ground terminals.

In certain embodiments, the insulating body is provided with an insertion plate, and the side plate is at least partially located on the insertion plate; and each of the signal terminals comprises a signal contact section, each of the ground terminals comprises a grounding contact section, and in the vertical direction, the grounding contact section and the signal contact section are exposed on a same surface of the insertion plate, and a free end of the side plate protrudes toward the insertion plate relative to the ground terminals.

Compared to the related art, the technical solution according to the present invention has the following beneficial effects:

To reduce the far-end crosstalk, the side plate shields the noise radiated outward by the adjacent signal terminal. Along the vertical direction, the projection of the ground terminal and the projection of the lossy member overlap with each other, and along the left-right direction, the projection of the side plate overlaps with the projection of the lossy member, such that a portion of a noise is transmitted to the lossy member and is attenuated, and the other portion of the noise continues to radiate outward. The ground terminal and the side plate provide the shielding functions at any of the upper side and the lower side and at any of the left side and the right side of the lossy member, and the other portion of the noise radiated outward may be shielded by the side plate, thereby reducing the far-end crosstalk.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is an exploded view of an electrical connector according to a first embodiment of the present invention.

FIG. 2 is an exploded view of a module according to the first embodiment of the present invention.

FIG. 3 is an overall view of a module according to the first embodiment of the present invention, in which the plastic body is removed.

FIG. 4 is a partial view of a module according to the first embodiment of the present invention, in which the plastic body is removed.

FIG. 5 is a sectional view along a line A-A in FIG. 4.

FIG. 6 is a partial view of a module according to the first embodiment of the present invention.

FIG. 7 is a structural schematic view of a grounding assembly according to the first embodiment of the present invention.

FIG. 8 is an overall view of a module according to a second embodiment of the present invention, in which the plastic body is removed.

FIG. 9 is a sectional view of a module according to the second embodiment of the present invention showing the same location as in FIG. 5, in which the plastic body is removed.

FIG. 10 is a simulation result chart of a first electrical connector model on the far-end crosstalk (FEXT).

FIG. 11 is a simulation result chart of a second electrical connector model on the FEXT.

FIG. 12 is a simulation result chart of a third electrical connector model on the FEXT.

FIG. 13 is a comparison diagram of the impact of the three electrical connector models on the FEXT.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

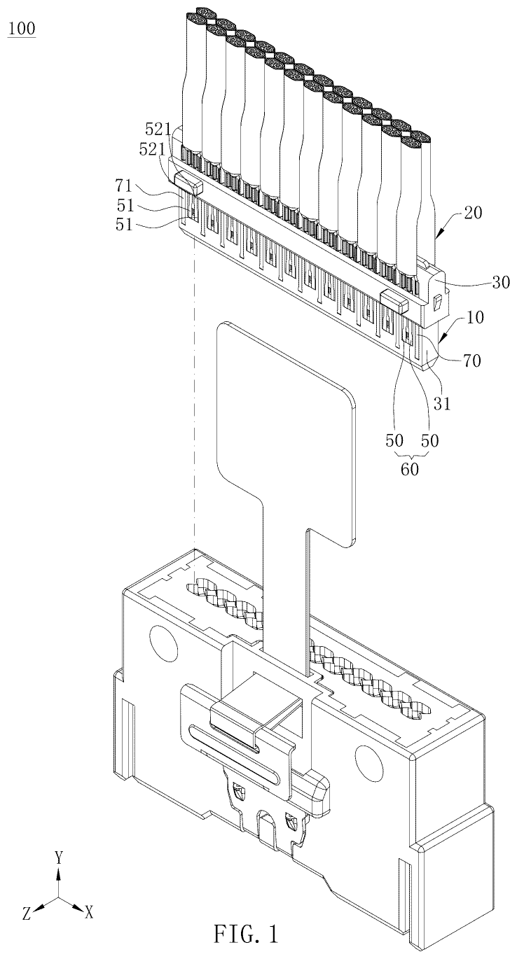

The description will be made as to the embodiments of the present invention in conjunction with the accompanying drawings in FIGS. 1-13. In accordance with the purposes of this invention, as embodied and broadly described herein, this invention, in one aspect, relates to an electrical connector.

For convenience of understanding the technical solutions of the present invention, in the three-dimensional coordinates as shown in the accompanying drawings, the X-axis is defined as a left-right direction, the Y-axis is defined as a front-rear direction, and the Z-axis is defined as a vertical direction. Any two of the X-axis, the Y-axis and the Z-axis are perpendicular to one another.

FIG. 1 to FIG. 7 shows a first embodiment of the present invention. The electrical connector 100 includes a module 10, and the module 10 includes an insulating body 30, a plurality of signal terminals 50, a plurality of ground terminals 71, a lossy member 90 and a shielding member 80. The insulating body 30 is provided with an insertion plate 31 to be inserted forward into an insertion slot of a mating connector (not shown). Each ground terminal 71 integrally extends toward the lossy member 90 to form a side plate 74, and along the vertical direction Z, a projection of the ground terminal 71 and a projection of the lossy member 90 overlap with each other. A grounding assembly 70 includes a plurality of ground terminals 71 and a plurality of side plates 74, and the ground terminals 71 and the side plates 74 are electrically conductive. In the present embodiment, a portion of each side plate 74 is located on the insertion plate 31. In other embodiments, each side plate 74 is completely located on the insertion plate 31. Two adjacent signal terminals 50 arranged side-by-side in the left-right direction form a differential signal pair 60. In other embodiments, it is possible not to transmit the differential signals and to transmit only single-ended signals, and thus no differential signal pair 60 is provided. The signal terminals 50 and the ground terminals 71 are arranged along the left-right direction X and are accommodated in the insulating body 30. Viewing from the vertical direction Z, the lossy member 90 is located between the two signal terminals 50. The lossy member 90 is located between the ground terminals 71 and the shielding member 80. The grounding assembly 70, the lossy member 90 and the shielding member 80 are assembled together in the vertical direction Z and are accommodated in the insulating body 30.

It should be noted that, in the present embodiment, the lossy member 90 is formed by a conductive plastic. In other embodiments, the lossy member 90 may be formed by other consumable medium material, and the consumable medium material may generate loss to the signal (energy). In the present embodiment, the electrical connector 100 includes terminals in two rows that are vertically symmetrical. The terminals in each row include a plurality of ground terminals 71 and a plurality of signal terminals 50. In other embodiments, the electrical connector 100 may be provided with only one row of terminals.

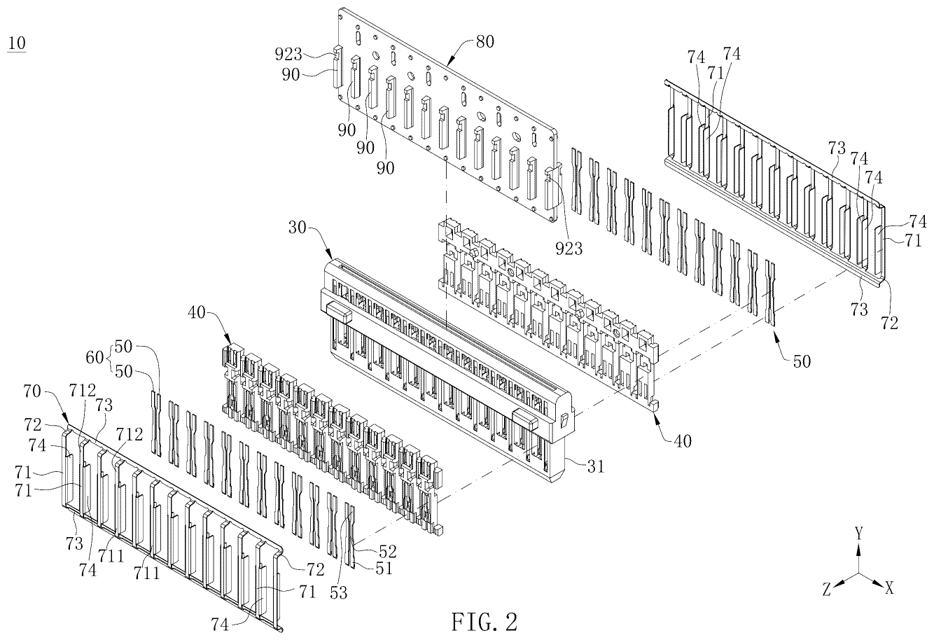

As shown in FIG. 2 to FIG. 5, the module 10 further includes a plastic body 40. The plastic body 40 includes a plurality of insulating members 41 and a plurality of insulating blocks 42, and the insulating members 41 and the insulating blocks 42 are insert-molded together. Each insulating block 42 includes a first end 421 in contact with the signal terminals 50 and a second end 422 in contact with the shielding member 80. Viewing from the front-rear direction Y, the lossy member 90 is located between the two insulating blocks 42. A first distance L1 exists between two adjacent first ends 421, and a second distance L2 exists between two adjacent second ends 422. The first distance L1 is greater than the second distance L2. In the present embodiment, the grounding assembly 70 is mounted in the vertical direction Z after the shielding member 80, the lossy member 90 and the insulating blocks 42 are mounted. Further, only a space between the two adjacent second ends 422 is required to be reserved for accommodating the side plate 74. Thus, the second distance L2 between the two adjacent second ends 422 is shorter than the first distance L1. Simultaneously, the short second distance L2 may limit the two side plates 74 on the same ground terminal 71 in the left-right direction, and a sufficient moving space between the two adjacent first ends 421 is required for the side plate 74 to adjust its position to be aligned with the lossy member 90. Thus, the first distance Ll is greater than the second distance L2.

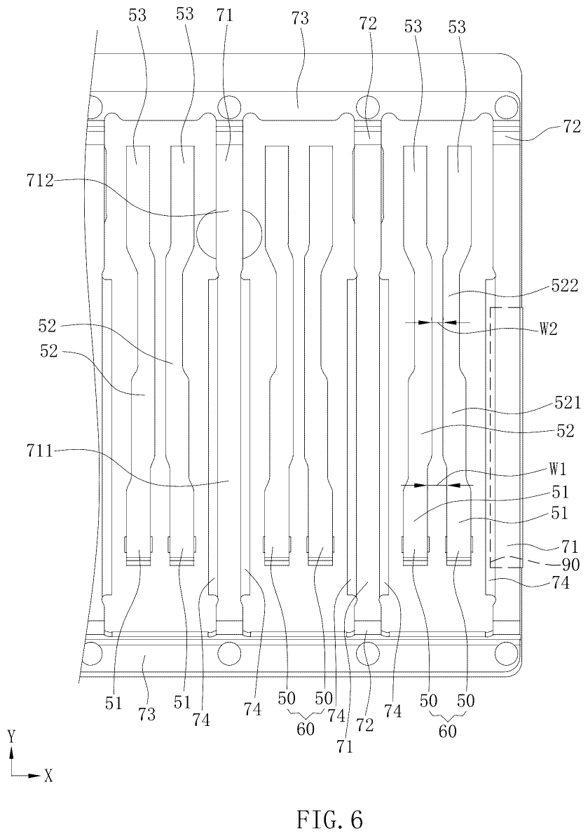

As shown in FIG. 1 and FIG. 6, the signal terminals 50 are arranged along the left-right direction X. Each signal terminal 50 includes a signal contact section 51, a signal transition section 52 and a signal soldering section 53. The signal transition section 52 is connected forward to the signal contact section 51 and is connected backward to the signal soldering section 53. A first clearance W1 exists between the two signal contact sections 51 of the same differential signal pair 60, and a second clearance W2 exists between the two signal transition sections 52 of the same differential signal pair 60. The first clearance W1 is greater than the second clearance W2, and the second clearance W2 is the minimum clearance between the two signal terminals 50 of each differential signal pair 60. The first clearance W1 is greater than the second clearance W2, such that the two signal transition sections 52 of the same differential signal pair 60 are tightly coupled, reducing the crosstalk between the two signal terminals 50 of the same differential signal pair 60. In the vertical direction Z, the signal contact section 51 is exposed on the surface of the insertion plate 31.

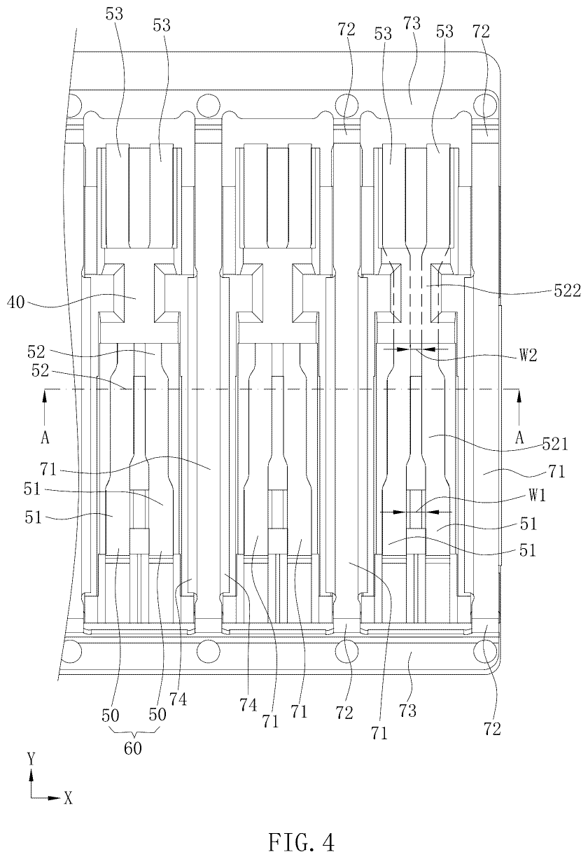

As shown in FIG. 1, FIG. 2, FIG. 4 and FIG. 6, along the front-rear direction Y, the signal transition section 52 includes a first section 521 exposed in the air and a second section 522 covered by the insulating body 30, and a width of the second section 522 is less than a width of the first section 521. Along the left-right direction X, a clearance between the first section 521 and the side plate 74 is less than a clearance between the second section 522 and the side plate 74. The first section 521 is exposed in the air, such that the impedance of the first section 521 is high, and the second section 522 is covered by the insulating body 30, such that the dielectric constant around the second section 522 is increased, thereby increasing the capacitance, and when the first section 521 and the second section 522 have equal widths, the impedance of the second section 522 is lower than that of the first section 521. To facilitate the impedance matching of the first section 521 and the second section 522, the width of the second section 522 of each signal terminal 50 is reduced such that the inductance is increased, and the impedance of the second section 522 is increased. In addition, since the side plates 74 are made of a metal material, when the clearance between each side plate 74 and the signal transition section 52 in the left-right direction X becomes smaller, the impedance of the signal transition section 52 becomes smaller. The second section 522 has a reduced width relative to the first section 521, such that in the left-right direction X, the clearance between the second section 522 and the side plate 74 is greater than the clearance between the first section 521 and the side plate 74, and when the medium around the first section 521 and the medium around the second section 522 are the same, the second section 522 has an increased impedance relative to the first section 521. In sum, by reducing the width of the second section 522, the second section 522 has a reduced width and an increased impedance, and the clearance between the second section 522 and the side plate 74 is increased to increase the impedance, thus balancing the reduced impedance of the second section 522 covered by the insulating body 30, and facilitating the impedance matching between the first section 521 and the second section 522. In addition, each ground terminal 71 includes a grounding contact section 711 and a grounding soldering section 712 connected forward to the grounding contact section 711. In the vertical direction Z, the grounding contact section 711 and the signal contact section 51 are both exposed on the same surface of the insertion plate 31, and the free end of each side plate 74 protrudes toward the insertion plate 31 relative to the ground terminals 71. The free end of each side plate 74 protruding toward the insertion plate 31 relative to the ground terminals 71 may increase the shielding range of the side plate 74 in the vertical direction, thus enhancing the shielding effect. In the present embodiment, the electrical connector 100 includes terminals in two rows, in which the grounding contact sections 711 and the signal contact sections 51 of the terminals in one row are exposed on an upper surface of the insertion plate 31, and the grounding contact sections 711 and the signal contact sections 51 of the terminals in the other row are exposed on an lower surface of the insertion plate 31. In other embodiments, the electrical connector 100 may be provided with only one row of the terminals.

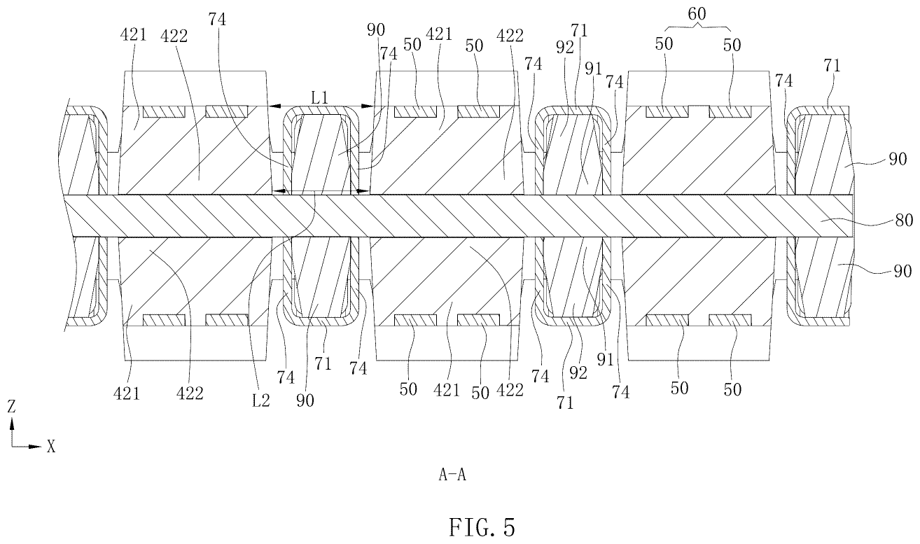

As shown in FIG. 5 to FIG. 7, in the present embodiment, each ground terminal 71 integrally extends toward the lossy member 90 along the vertical direction Z to form two side plates 74. A portion of each side plate 74 is located between the signal transition section 52 and the grounding contact portion 711, and each side plate 74 has another portion located between the signal contact portion 51 and the grounding contact portion 711. In other embodiments, each side plate 74 may be located only between the signal transition section 52 and the ground terminal 71. In other words, it is possible that, along the front-rear direction Y, each side plate 74 does not pass beyond the signal transition section 52. In other embodiments, it is possible that each ground terminal 71 may extend to form only one side plate 74. Viewing from the vertical direction Z, the ground terminal 71 is located between two differential signal pairs 60, and the lossy member 90 is located between two differential signal pairs 60. The ground terminal 71 and the differential signal pairs 60 are arranged along the left-right direction X and are accommodated in the insulating body 30, and the side plates 74 are located at the sides of the differential signal pair 60 to increase the metal shielding, thereby reducing the crosstalk between the adjacent differential signal pairs 60. The two signal transition sections 52 of the same differential signal pair 60 are at the high impedance point, and the two signal transition sections 52 of the differential signal pair 60 are tightly coupled to reduce the impedance, thus facilitating the impedance matching. Along the left-right direction X, the two plate surfaces of the side plate 74 are opposite to each other, and the projection of the side plate 74 and the projection of the signal transition section 52 overlap with each other. That is, the side plate 74 is located at a side of the signal transition section 52. The two signal transition sections 52 of the same differential signal pair 60 are tightly coupled, which may reduce the crosstalk between the two differential signal pairs 60. However, the energy radiated outward by the two signal transition sections 52 may interfere the other differential signal pairs 60, and when the side plates 74 are located at the sides of the signal transition sections 52, the side plates 74 may reflect the energy, such that the energy does not impact the surrounding differential signal pairs 60, thus reducing the crosstalk, which is conducive to satisfying the high frequency requirements. In the present embodiment, each side plate 74 has only a portion located at the side of the signal transition section 52. In other embodiments, if it is only required to reduce the crosstalk around the signal transition section 52, that is, reducing the crosstalk of the tight coupling region of the differential signal pair 60, the side plate 74 may be completely located at the side of the signal transition section 52.

As shown in FIG. 6, in the present embodiment, along the left-right direction, the side plate 74 is not located at any side of the signal soldering section 53. That is, in the front-rear direction Y, the side plate 74 does not extend to the signal soldering section 53 of the ground terminal 71. This is because the signal soldering section 53 is soldered to the conductor exposed from the cable 20, the signal soldering section 53 has a solder, and the solder generally contains metal. The signal soldering section 53 of the signal terminal 50 has a lower impedance due to the existence of the solder and the conductor exposed from the cable 20. Since the side plate 74 is made of the metal material, if the side plate 74 extends to the side of the signal soldering section 53 of the ground terminal 71, the metal adjacent to the signal terminal 50 increases, such that the impedance becomes lower, which is not conducive to the impedance matching. Meanwhile, the ground soldering section 712 may be soldered to the conductor exposed from the cable 20, and the impedance of the grounding soldering section 712 is also low. To facilitate impedance matching, the side plate 74 does not extend to the side of the signal soldering section 53. Specifically, in the present embodiment, viewing from the vertical direction Z, the side plate 74 is not located between the signal soldering section 53 and the grounding soldering section 712. In other embodiments, as long as the impedance matching may be achieved without affecting the signal transmission completeness, the side plate 74 may extend to the signal soldering section 53. In addition, in other embodiments, it is possible that the signal soldering section 53 of the ground terminal 71 is not soldered to the cable 20, as long as the signal soldering section 53 may facilitate electrical conduction with other electrical components.

As shown in FIG. 5, in the present embodiment, the lossy member 90 is accommodated in the insertion plate 31. Along the vertical direction Z, a projection of the lossy member and a projection of the ground terminal 71 overlap with each other. Specifically, the ground terminal 71 is located above the lossy member 90 and is in contact with the lossy member 90, and the free ends of the two side plates 74 are respectively in contact with the shielding member 80. The two side plates 74 are located at a left side and a right side of the lossy member 90 and are respectively in contact with the lossy member 90. A noise of the grounding assembly 70 is mainly concentrated on the two side plates 74 by the conduction of the ground terminal 71. The side plates 74 are in contact with the lossy member 90, and the lossy member 90 is formed by a consumable medium material. Thus, the noise on the side plates 74 may be absorbed by the lossy member 90, thereby facilitating the zero potential of the grounding assembly 70, reducing the crosstalk and satisfying the high frequency requirements. In the present embodiment, the ground terminal 71 is located above the lossy member 90, and the two side plates 74 are located at the left side and the right side of the lossy member 90. The ground terminal 71 and the two side plates 74 surrounds three surfaces of the lossy member 90, thus blocking the noise from scattering outward, and reducing the impact range. Meanwhile, the lossy member 90 absorbs the noise, thus reducing the crosstalk. To ensure the zero potential of the grounding assembly 70, the free ends of the side plates 74 are in contact with the shielding member 80, thus increasing the grounding paths, such that the noise on the side plates 74 may be transmitted to the shielding member 80 to be grounded, and may be absorbed by the lossy member 90, thereby satisfying the high frequency requirements.

In other embodiments, after satisfying the conditions where the ground terminal 71 is in contact with the lossy member 90 along the vertical direction Z and the side plate 74 is in contact with the lossy member 90 along the left-right direction X, it is possible that the side plate 74 is not in contact with the shielding member 80. In other words, in the vertical direction Z, a height of the side plate 74 is less than a height of the lossy member 90 located above the shielding member 80. The side plate 74 may also be conductive with the shielding member 80 by being in contact with the lossy member 90.

As shown in FIG. 6, along the left-right direction X, a projection of the side plate 74 overlaps with a projection of the lossy member 90. To reduce the signal interference strength, the lossy member 90 is added such that the lossy member 90 is located between the ground terminal 71 and the shielding member 80. The ground terminal 71 is located above the lossy member 90, and the two side plates 74 are located at the left side and the right side of the lossy member 90. A portion of the noise is transmitted to the lossy member 90 and is attenuated, and the other portion of the noise continues to radiate outward. In this case, due to the shielding effect of the ground terminal 71 and the side plates 74 above and at the two sides of the lossy member 90, the outward radiated noise may be shielded by the side plates 74, thus reducing the range affected by the outward radiated noise. It should be noted that the lossy member 90 is made of a consumable medium material, and the shielding of the lossy member 90 is mainly achieved by absorbing energy. The small gaps between the lossy member 90 and the side plates 74 may also absorb the noise on the side plates 74.

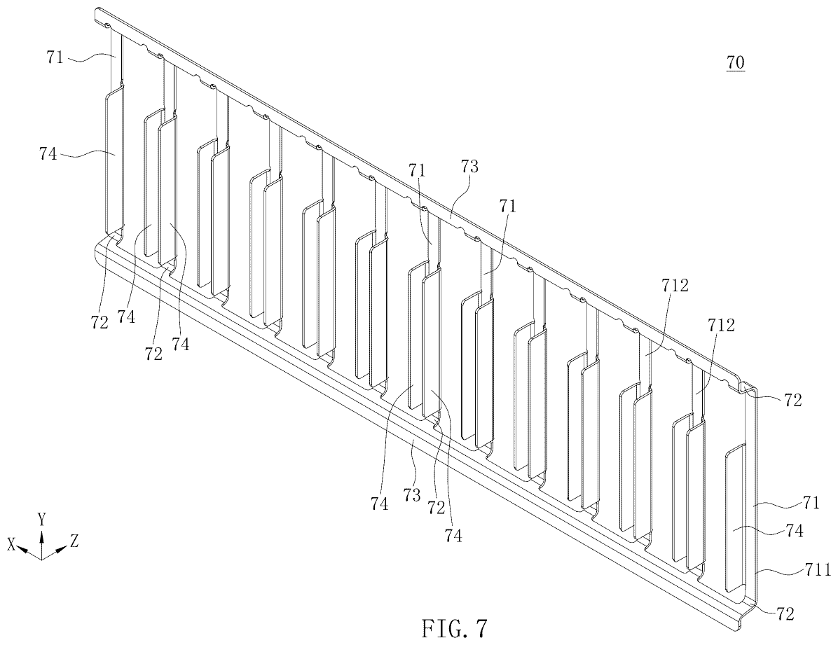

As shown in FIG. 2 and FIG. 7, in the present embodiment, the grounding assembly 70 further includes a connecting portion 72. In other embodiments, the grounding assembly 70 may include only the ground terminals 71 and the side plates 74. Each ground terminal 71 integrally bends and extends along the front-rear direction Y to form two connecting portions 72. Specifically, a front end of each ground terminal 71 bends toward the insertion plate 31 to form a connecting portion 72, and a back end of each ground terminal 71 bends toward the insertion plate 31 to form a connecting portion 72. The connecting portions 72 located at the front sides of the ground terminals 71 are connected in series by a bridge component 73, and the connecting portions 72 located at the rear sides of the ground terminals 71 are connected in series by another identical bridge component 73. The bridge components 73 connects the ground terminals 71 in series for grounding, thus reducing the signal residual effect, i.e., reducing the crosstalk, and facilitating the signal transmission completeness. In other embodiments, each ground terminal 71 may be provided with only one connecting portion 72 along the front-rear direction, and the connecting portion 72 may be located at the front side or the rear side of the ground terminal 71. Alternatively, each ground terminal 71 may be provided with no connecting portion 72.

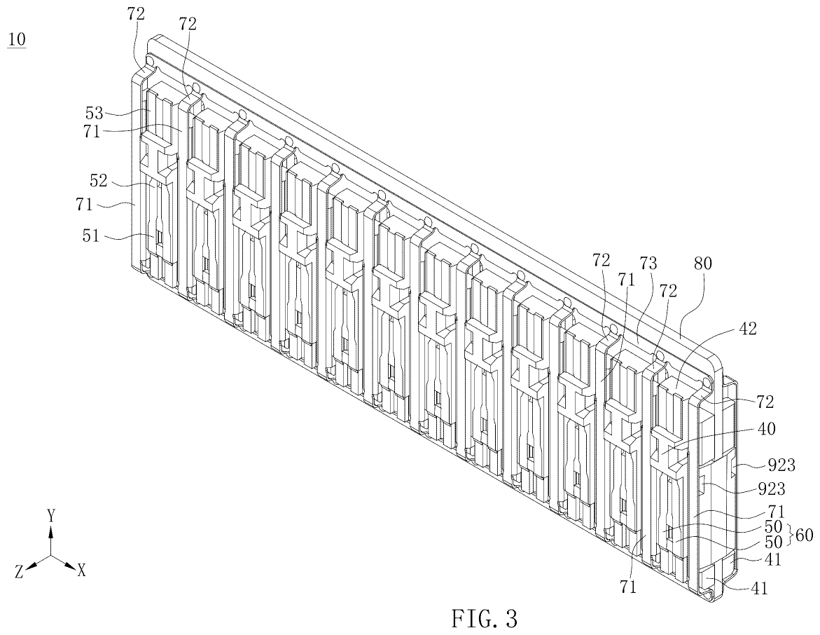

As shown in FIG. 3, in the front-rear direction Y, an insulating member 41 is provided in front of the lossy member 90. That is, an insulating member 41 is provided between the connecting portion 72 at the front side of each ground terminal 71 and the lossy member 90. In the vertical direction Z, the insulating member 41 is located between the shielding member 80 and the ground terminal 71 and abuts against the ground terminal 71, and the insulating member 41 supports the ground terminal 71. In the left-right direction X, a projection of the insulating member 41 and the projection of the side plate 74 at least partially overlap with each other. In the present embodiment, for convenience of forming, the adjacent insulating members 41 are connected together. In other embodiments, the insulating members 41 may be independently provided.

As shown in FIG. 2, FIG. 3 and FIG. 5, along the vertical direction Z, the lossy member 90 is located between the ground terminal 71 and the shielding member 80. In the present embodiment, the lossy member 90 is embedded on the upper surface and the lower surface of the shielding member 80. In other embodiments, the mounting method of the shielding member 80 and the lossy member 90 is not limited to insert-molding, assembly, etc., as long as the electrical conduction between the shielding member 80 and the lossy member 90 may be facilitated. For example, the lossy member 90 may be adhered to the shielding member 80 by a conductive adhesive. Along the vertical direction Z, the lossy member 90 includes a first portion 91 in contact with the shielding member 80 and a second portion 92 connected to the first portion 91, and the first portion 91 is located between the second portion 92 and the shielding member 80. Along the left-right direction X, the first portion 91 is in contact with the side plate 74, and the second portion 92 is not in contact with the side plate 74. The noise on the ground terminal 71 is transmitted through the side plate 74. In the vertical direction Z, a side of the side plate 74 away from the ground terminal 71 has an edge effect, such that the noise is concentrated thereon. In the left-right direction X, the first portion 91 of the lossy member 90 is in contact with the side plate 74 and may absorb the noise, and the unabsorbed portion may be grounded by the path of the side plate 74—the lossy member 90—the shielding member 80 along the vertical direction Z, thereby reducing the crosstalk. Meanwhile, since the noise on the grounding assembly 70 is concentrated at the side of the side plate 74 away from the ground terminal 71, the second portion 92 of the lossy member 80 is not in contact with the side plate 74 in the left-right direction and still achieves the effect of reducing the crosstalk.

As shown in FIG. 2 to FIG. 3, along the vertical direction Z, the second portion 92 is in contact with the ground terminal 71, and a slot 923 exists between the second portion 92 and the ground terminal 71. In other embodiments, it is possible to provide a plurality of slots 923 or that no slot 923 is provided. The slot 923 exists between the second portion 92 and the ground terminal 71, such that a gap exists between the ground terminal 71 and the second portion 92, and the ground terminal 71 and the second portion 92 are not in contact at the location of the slot 923. The slot 923 is provided to reduce the energy loss of the side of the side plate 74 adjacent to the ground terminal 71. Specifically, the air is a zero-loss medium, and the lossy member is formed by a consumable medium material. The consumable medium causes loss to any signal, which does not exhibit selectivity that may only consume the noise. Thus, the side of the side plate 74 away from the ground terminal 71 is in contact with the lossy member 90, which may achieve the effect of reducing the crosstalk. The side of the side plate 74 adjacent to the ground terminal 71 is provided with the slot 923, and the air is contained in the slot 923 to reduce the signal loss in the region. Thus, the energy absorbing characteristics of the lossy member 90 may be utilized to absorb the noise, without causing the lossy member 90 to absorb excessive energy and affecting the completeness of the signal.

As shown in FIG. 6, in the front-rear direction Y, a front end surface of the side plate 74 passes forward beyond a front end surface of the lossy member 90, and the front end surface of the lossy member 90 passes forward beyond a front end surface of the signal terminal 50, and a rear end surface of the side plate 74 passes backward beyond a rear end surface of the lossy member 90. More electromagnetic waves and interference signals are scattered outward from the front end of the signal terminal 50, and in the ideal condition, the front end surface of the lossy member 90 and the front end surface of the signal terminal 50 are flush, thus reducing the signal concentration of the front end of the signal terminal 50 and reducing the crosstalk. The front end surface of the lossy member 90 passing forward beyond the front end surface of the signal terminal 50 may absorb more of the electromagnetic waves and the interference signals, thus reducing the crosstalk around the front end surface of the signal terminal 50. The front end surface of the side plate 74 passing forward beyond the front end surface of the lossy member 90 may reduce the far-end crosstalk. In the present embodiment, in the front-rear direction Y, the front end surface of the lossy member 90 is located between the front end surface of the signal terminal 50 and the front end surface of the side plate 74. In other embodiments, the front end surface of the lossy member 90 may be flush with the front end surface of the signal terminal 50.

Along the front-rear direction Y, a clearance between the front end surface of the side plate 74 and the front end surface of the signal terminal 50 is greater than or equal to a clearance between the front end surface of the side plate 74 and a front end of the ground terminal 71. Since signal concentration occurs at the front end of the signal terminal 50, the side plate 74 extends forward beyond the front end surface of the signal terminal 50 to shield the interference signals of the front end of the signal terminal 50, thus reducing the crosstalk. When the clearance between the front end surface of the side plate 74 and the front end surface of the signal terminal 50 becomes greater, the energy radiated outward by the signal terminal 50 that may be shielded by the side plate 74 is more. The clearance exists between the front end of the ground terminal 71 and the front end surface of the side plate 74 to reserve for the processing space, which is convenient for performing stamping and bending to the plate surface on which the ground terminal 71 is located to form the side plate. Thus, there is no need for a large clearance. To enhance the high frequency characteristics, in the present embodiment, the clearance between the front end surface of the side plate 74 and the front end surface of the signal terminal 50 is greater than a distance between the front end surface of the side plate 74 and the front end surface of the ground terminal 71.

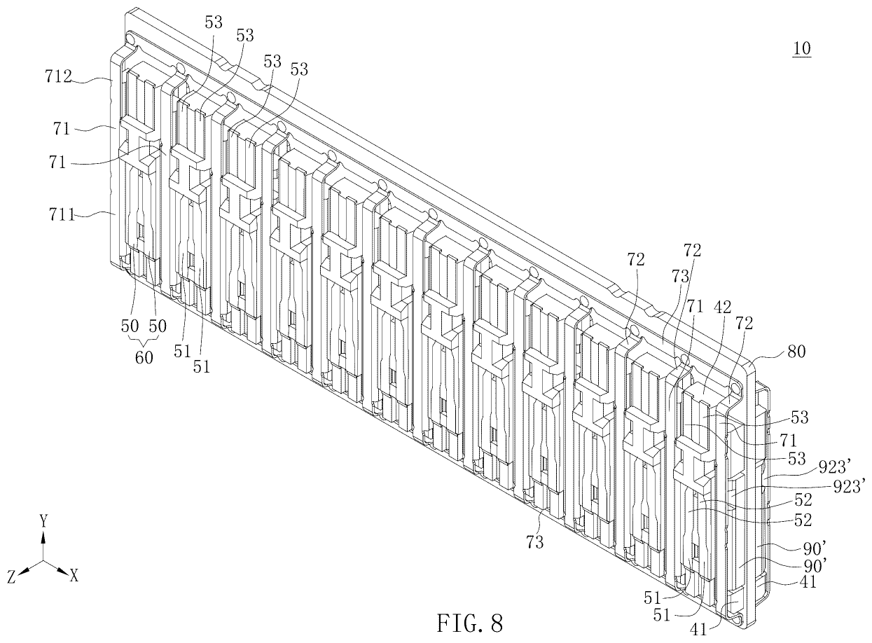

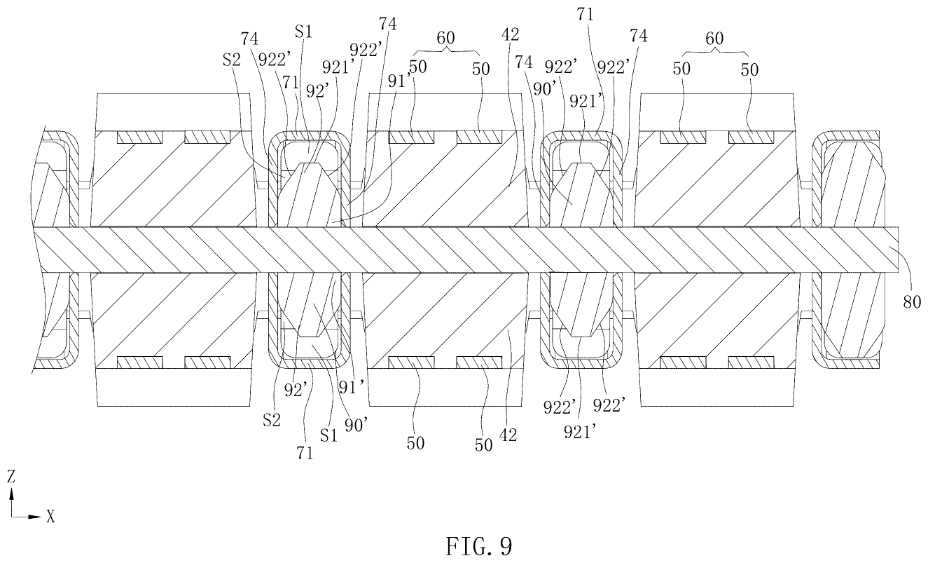

FIG. 8 to FIG. 9 show a second embodiment of the present invention. The lossy member 90′ in the second embodiment and the lossy member 90 in the first embodiment have different structures, but both are made of the conductive plastic. In the present embodiment, in the vertical direction Z, the lossy member 90′ is located between the ground terminal 71 and the shielding member 80, the side plate 74 is in contact with the shielding member 80, and a gap exists between the ground terminal 71 and the lossy member 90′. Each ground terminal 71 extends toward the lossy member 90′ to form two side plates 74. In other embodiments, each ground terminal 71 may extend toward the lossy member 90′ to form a single side plate 74. The ground terminal 71 and the side plate 74 are assembled with the lossy member 90′ in the vertical direction Z. Considering the manufacturing tolerances and mounting convenience, a gap exists between the ground terminal 71 and the lossy member 90′ in the vertical direction Z, thus ensuring that the grounding assembly 70 may be smoothly mounted with the lossy member 90′ and the shielding member 80, and the free end of the side plate 74 may be in contact with the shielding member 80 to facilitate the electrical conductivity with the shielding member 80. In addition, due to the edge effect of the conductor, and the fact that the side plate 74 is a metal plate, the noise on the ground terminal 71 is transmitted to the side plate 74 and is concentrated at the edge of the side plate 74. That is, the noise is concentrated on the free end of the side plate 74. Further, the lossy member 90′ on the shielding member 80 is in contact with the side plate 74, such that the concentrated noise on the side plate 74 may be absorbed by the lossy member 90′, thereby reducing the crosstalk.

As shown in FIG. 8, in the front-rear direction Y, an insulating member 41 is provided in front of the lossy member 90′. In the vertical direction Z, the insulating member 41 is located between the shielding member 80 and the ground terminal 71 and abuts against the ground terminal 71. In the left-right direction X, a projection of the insulating member 41 and the projection of the side plate 74 at least partially overlap with each other. When the lossy member 90′ is not in contact with the ground terminal 71, i.e., a gap exists between the two in the vertical direction Z, the ground terminal 71 lacks the support and may easily bend. Thus, the insulating member 41 is provided in front of the lossy member 90′ and abuts against the ground terminal 71 to provide the support for the ground terminal 71. In the present embodiment, for convenience of forming, the adjacent insulating members 41 are connected together. In other embodiments, the insulating members 41 may be independently provided.

As shown in FIG. 8, along the vertical direction Z, the lossy member 90′ includes a first portion 91′ in contact with the shielding member 80 and a second portion 92′ connected to the first portion 91′, and the first portion 91′ is located between the second portion 92′ and the shielding member 80. Along the left-right direction X, the first portion 91′ is in contact with the side plate 74, and the second portion 92′ is not in contact with the side plate 74. Along the vertical direction Z, the second portion 92′ is in contact with the ground terminal 71, and a slot 923′ exists between the second portion 92′ and the ground terminal 71. In other embodiments, it is possible to provide a plurality of slots 923′ or that no slot 923′ is provided.

As shown in FIG. 9, further, the second portion 92′ includes a first surface 921′ and at least one second surface 922′ connected to the first surface 921′. Along the vertical direction Z, a first gap SI exists between the first surface 921′ and the ground terminal 71. Along the left-right direction X, a second gap S2 exists between the second surface 922′ and the ground terminal 71. The first gap S1 is in communication with the second gap S2, and air is respectively filled in the first gap S1 and the second gap S2. Along the vertical direction Z, a width of the second gap S2 becomes narrower in a direction from the second portion 92′ toward the first portion 91′. The lossy member 90′ is formed by a consumable medium material, and the consumable medium causes loss to any signal, which does not exhibit selectivity that may only consume the noise. In addition, the side of the side plate 74 away from the ground terminal 71 has the edge effect, and the noise is concentrated. Thus, the side of the side plate 74 away from the ground terminal 71 is in contact with the lossy member 90, which may achieve the effect of reducing the crosstalk. The air is a zero-loss medium, the side of the side plate 74 adjacent to the ground terminal 71 contains the air to reduce the signal loss in the region, thus preventing from the impact to the completeness of the signal. In addition, the second gap S2, which is provided in the vertical direction Z, may prevent the side of the ground terminal 71 close downward to the lossy member 90′ from interfering with the lossy member 90′ in the mounting process and damaging the ground terminal 71 and the lossy member 90′, thus enhancing the usage life span of the electrical connector 100. The lossy member 90′ may absorb the noise without being in contact with the side plate 74, and the second gap S2 becomes narrower, i.e., a distance between the second surface 922′ of the second portion 92′ and the side plate 74 is shortened, such that the second portion 92′ may more easily absorb the noise. Since the noise on the side plate 74 is mainly concentrated at the side of the side plate 74 away from the ground terminal 74, the width of the second gap S2 becoming narrower in the direction from the second portion 92′ toward the first portion 91′ is conducive to assisting the first portion 91′ of the lossy member 90′ to absorb the noise.

Further, the size of the first clearance S1 may be adjusted based on the actual requirements, as long as it is convenient for assembling the grounding assembly with the lossy member 90′ and the shielding member 80, and the first gap S1 contains the air medium. In the present embodiment, a height of the second gap S2 in the vertical direction Z, i.e., a distance between an upper surface of the second portion 92′ and a lower surface of the ground terminal 71, does not exceed 20 mm. In other embodiments, as long as it is satisfied that the first portion 91′ is in contact with the side plate 74 to absorb the noise, the height of the second gap S2 in the vertical direction Z may be freely selected.

In addition, the inventors of the present invention have performed simulation analysis to three electrical connector models. The differences between the three electrical connector models exist only in the side plate 74 and the lossy member 90, and other components and the structural relationships are consistent. In the first electrical connector model, the lossy member 90 is provided to be in contact with the ground terminal 71. In the second electrical connector model, the left side and the right side of the ground terminal 71 respectively extend downward to form two side plates 74, and is not provided with the lossy member 90 to be in contact with the ground terminal 71. In the third electrical connector model, the left side and the right side of the ground terminal 71 respectively extend downward to form two side plates 74, and the lossy member 90 is provided to be in contact with the ground terminal 71. In addition, the inclined line in each simulation result chart is a spec line of the PCIe 6.0 standard related to the FEXT, which is convenient for determining whether the FEXT of each electrical connector 100 model achieves the standard.

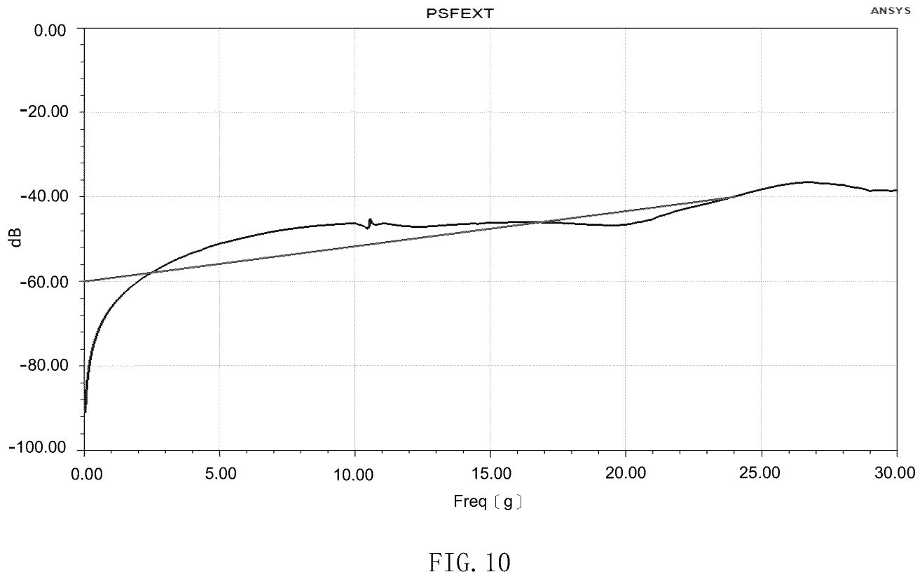

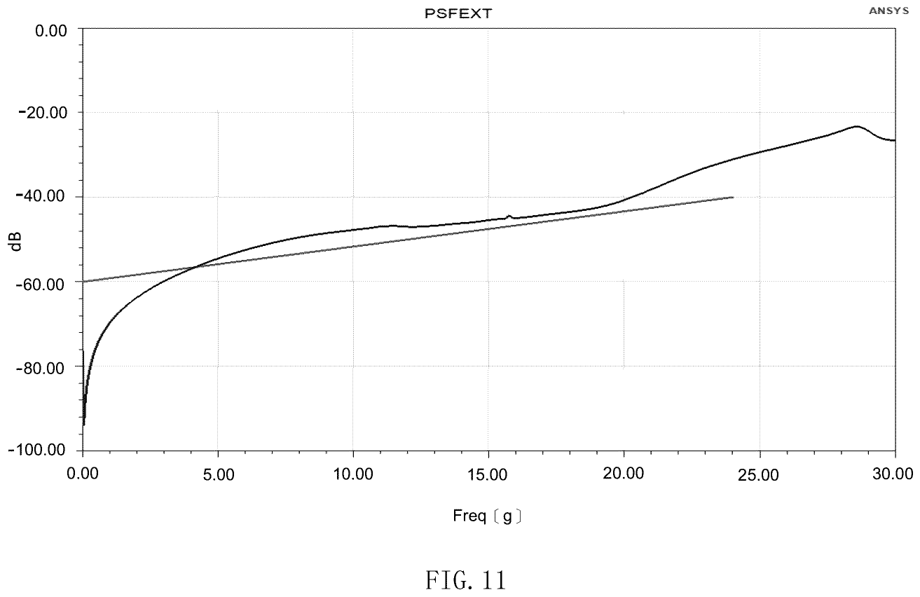

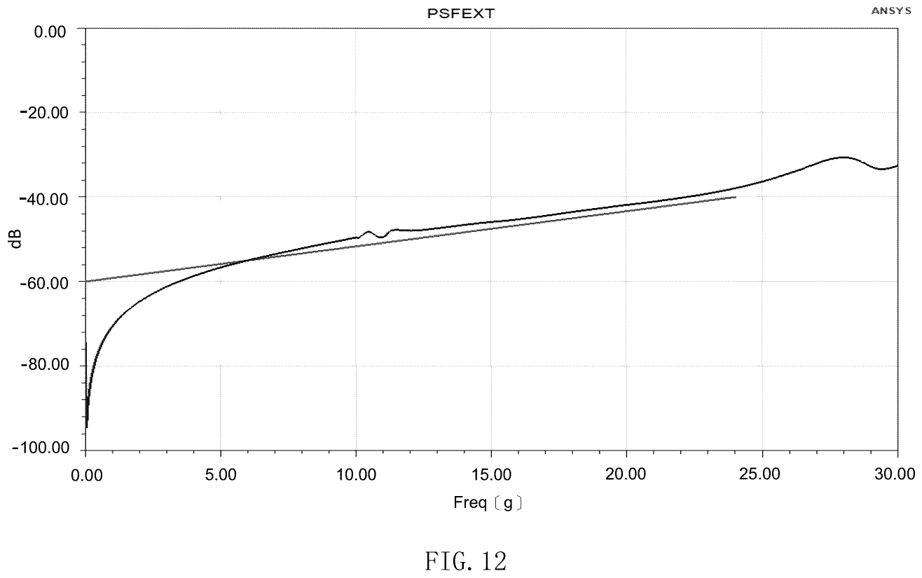

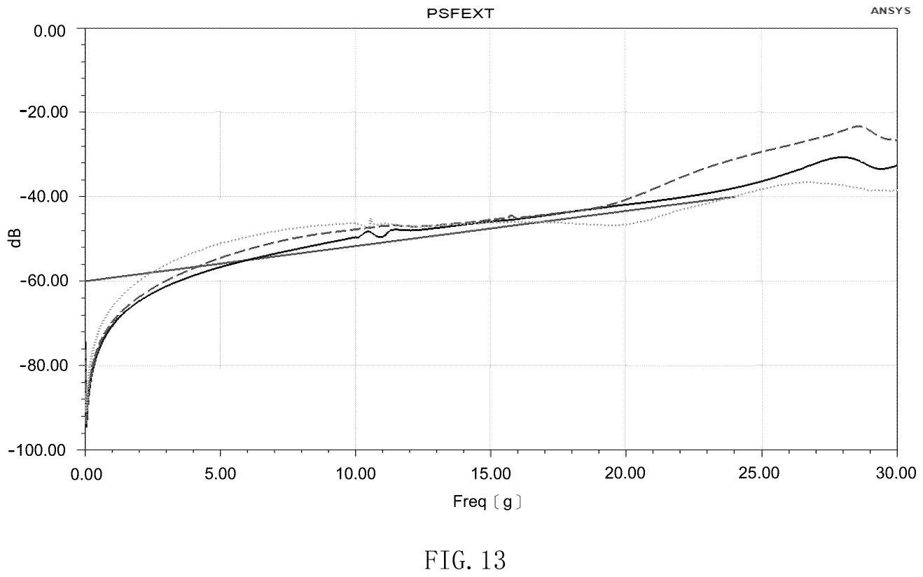

FIG. 10 is a simulation result chart of a first electrical connector model on the far-end crosstalk (FEXT). As shown in the simulation result chart, the FEXT generated in the high frequency band, i.e., around 20 GHz, has an intensity below the spec line, indicating less FEXT. However, in the mid-to-low frequency band, i.e., between 0 and 15 GHz, the FEXT has an intensity above the spec line, indicating more FEXT. FIG. 11 is a simulation result chart of a second electrical connector model on the FEXT. When only the two side plates 74 are provided to extend at the left side and the right side of the ground terminal 71, the FEXT in the mid frequency band, i.e., near 15 GHz, is closer to the spec line, and around the low frequency band (less than 15 GHZ) and the high frequency band (20 GHz), the FEXT intensities are both greater than the spec line. Thus, by providing only the two side plates 74 to extend at the left side and the right side of the ground terminal 71, the FEXT of the electrical connector 100 in the mid frequency band may be reduced. FIG. 12 is a simulation result chart of a third electrical connector model on the FEXT. The third electrical connector model is the electrical connector in the first embodiment, and as shown in the simulation result chart, in the entire frequency band, the FEXT is close to the spec line, and thus this model may further reduce the FEXT. FIG. 13 is a comparison diagram of the impact of the three electrical connector models on the FEXT. As shown in the figure, the third electrical connector model, i.e., the design in which the left side and the right side of the ground terminal 71 respectively extend downward to form two side plates 74 and the lossy member 90 is provided to be in contact with the ground terminal 71, may reduce the FEXT compared to the first electrical connector model and the second electrical connector model.

It should be noted that, in the same simulation result chart, the frequency bands are relatively divided into a low frequency band, a mid frequency band and a high frequency band, without meaning that the boundaries between the low frequency band, the mid frequency band and the high frequency band are specifically 15 GHz and 20 GHz.

In sum, the electrical connector 100 according to certain embodiments of the present invention has the following beneficial effects:
(1) To reduce the far-end crosstalk, the side plate 74 shields the interference signals scattered outward by the adjacent signal terminal 50. Along the vertical direction Z, the projection of the ground terminal 71 and the projection of the lossy member 90 overlap with each other, and along the left-right direction X, the projection of the side plate 74 overlaps with the projection of the lossy member 90, such that a portion of a noise is transmitted to the lossy member 90 and is attenuated, and the other portion of the noise continues to radiate outward. The ground terminal 71 and the side plate 74 provide the shielding functions at any of the upper side and the lower side and at any of the left side and the right side of the lossy member 90, and the other portion of the noise scattered outward may be shielded by the side plate 74, thereby reducing the impact range of the interference signal and reducing the far-end crosstalk.
(2) The ground terminal 71 and the side plate 74 are electrically conductive, and viewing from the vertical direction Z, the side plate 74 is located between the ground terminal 71 and the differential signal pairs 60. Along the left-right direction X, the two plate surfaces of the side plate 74 are opposite to each other, and the projection of the side plate 74 and the projection of the signal transition section 52 overlap with each other. That is, shielding is added at the side of the signal transition section 52. Such design may reduce the impact of the energy radiated outward by the signal transition section 52 on other differential signal pairs 60, thereby reducing the crosstalk and satisfying the high frequency requirements. In addition, the first clearance W1 is greater than the second clearance W2, and the second clearance W2 is the minimum clearance between the two signal terminals 50 of each differential signal pair 60, such that the two signal transition sections 52 of the same differential signal pair 60 are tightly coupled, reducing the crosstalk between the two differential signal pairs 60 to satisfy the high frequency requirements.
(3) The lossy member 90 is located between the ground terminal 71 and the shielding member 80 and is in contact with the ground terminal 71 and the two side plates 74 are respectively in contact with the shielding member 80. The two side plates 74 are located at a left side and a right side of the lossy member 90 and are respectively in contact with the lossy member 90. The noise of the grounding assembly 70 is mainly concentrated on the two side plates 74 by the conduction of the ground terminal 71. The side plates 74 are in contact with the lossy member 90, and the lossy member 90 is formed by a consumable medium material. Thus, the noise on the side plates 74 may be absorbed by the lossy member 90, thereby facilitating the zero potential of the grounding assembly 70, reducing the crosstalk and satisfying the high frequency requirements. The ground terminal 71 and the two side plates 74 surrounds three surfaces of the lossy member 90, thus blocking the noise from scattering outward, and reducing the impact range. Meanwhile, the lossy member 90 absorbs the noise, thus reducing the crosstalk. To ensure the zero potential of the grounding assembly 70, the side plates 74 are in downward contact with the shielding member 80, thus increasing the grounding paths, such that the noise on the side plates 74 may be transmitted to the shielding member 80 to be grounded, and may be absorbed by the lossy member 90, thereby satisfying the high frequency requirements.
(4) Along the vertical direction Z, the second portion 92 is in contact with the ground terminal 71, and a slot 923 exists between the second portion 92 and the ground terminal 71. The slot 923 is provided to reduce the energy loss of the side of the side plate 74 adjacent to the ground terminal 71. Specifically, the air is a zero-loss medium, and the lossy member 90 is formed by a consumable medium material. The consumable medium causes loss to any signal, which does not exhibit selectivity that may only consume the noise. Thus, the side of the side plate 74 away from the ground terminal 71 is in contact with the lossy member 90, which may achieve the effect of reducing the crosstalk, the side of the side plate 74 adjacent to the ground terminal 71 is provided with the slot 923, and the air is contained in the slot 923 to reduce the signal loss in the region. Thus, the energy absorbing characteristics of the lossy member 90 may be utilized to absorb the noise, without causing the lossy member 90 to absorb excessive energy and affecting the completeness of the signal.
(5) In the front-rear direction Y, a front end surface of the side plate 74 passes forward beyond a front end surface of the lossy member 90, and the front end surface of the lossy member 90 passes forward beyond a front end surface of the signal terminal 50, and a rear end surface of the side plate 74 passes backward beyond a rear end surface of the lossy member 90. More electromagnetic waves and interference signals are scattered outward from the front end of the signal terminal 50, and in the ideal condition, the front end surface of the lossy member 90 and the front end surface of the signal terminal 50 are flush, thus reducing the signal concentration of the front end of the signal terminal 50 and reducing the crosstalk. The front end surface of the lossy member 90 passing forward beyond the front end surface of the signal terminal 50 may absorb more of the electromagnetic waves and the interference signals, thus reducing the crosstalk around the front end surface of the signal terminal 50. The front end surface of the side plate 74 passing forward beyond the front end surface of the lossy member 90 may reduce the far-end crosstalk.
(6) Along the vertical direction Z, a first gap S1 exists between the first surface 921′ and the ground terminal 71. Along the left-right direction X, a second gap S2 exists between the second surface 922′ and the ground terminal 71. The first gap S1 is in communication with the second gap S2, and air is respectively filled in the first gap S1 and the second gap S2. Along the vertical direction Z, a width of the second gap S2 becomes narrower in a direction from the second portion 92′ toward the first portion 91′. The lossy member 90′ may absorb the noise without being in contact with the side plate 74, and the second gap S2 becomes narrower, i.e., a distance between the second surface 922′ of the second portion 92′ and the side plate 74 is shortened, such that the second portion 92′ may more easily absorb the noise. Since the noise on the side plate 74 is mainly concentrated at the side of the side plate 74 away from the ground terminal 74, the width of the second gap S2 becoming narrower in the direction from the second portion 92′ toward the first portion 91′ is conducive to assisting the first portion 91′ of the lossy member 90′ to absorb the noise.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body;
a plurality of signal terminals and a plurality of ground terminals, arranged along a left-right direction and accommodated in the insulating body; and
a lossy member, wherein along a vertical direction, a projection of at least one of the ground terminals and a projection of the lossy member overlap with each other;
wherein at least one of the ground terminals integrally extends toward the lossy member to form at least one side plate, and along the left-right direction, a projection of the side plate and the projection of the lossy member overlap with each other.

2. The electrical connector according to claim 1, wherein at least one of the ground terminals integrally extends toward the lossy member to form two side plates, and the two side plates are respectively located at a left side and a right side of the lossy member and are respectively in contact with the lossy member.

3. The electrical connector according to claim 1, further comprising a shielding member accommodated in the insulating body, wherein:
along the vertical direction, the lossy member is located between the ground terminals and the shielding member; and
at least one of the ground terminals integrally extends toward the lossy member to form two side plates, and the two side plates are respectively located at a left side and a right side of the lossy member and are respectively in contact with the lossy member, and the two side plates are respectively in contact with the shielding member.

4. The electrical connector according to claim 1, further comprising a shielding member accommodated in the insulating body, wherein:
along the vertical direction, the lossy member is located between the ground terminals and the shielding member, a gap exists between the lossy member and at least one of the ground terminals, and the side plate is in contact with the shielding member; and
along the left-right direction, the side plate is in contact with the lossy member.

5. The electrical connector according to claim 4, wherein:
along a front-rear direction, an insulating member is provided in front of the lossy member;
along the vertical direction, the insulating member is located between the shielding member and the ground terminals, and the insulating member abuts against the ground terminals; and
along the left-right direction, a projection of the insulating member and the projection of the side plate at least partially overlap with each other.

6. The electrical connector according to claim 1, further comprising a shielding member accommodated in the insulating body, wherein:
in the vertical direction, the lossy member is located between the ground terminals and the shielding member, and at least one of the ground terminals is in contact with the lossy member; and
in the left-right direction, the side plate is in contact with the lossy member.

7. The electrical connector according to claim 1, wherein in a front-rear direction, a front end surface of the side plate passes forward beyond a front end surface of the lossy member, the front end surface of the lossy member passes forward beyond a front end surface of each of the signal terminals or is flush with the front end surface of each of the signal terminals, and a rear end surface of the side plate passes backward beyond a rear end surface of the lossy member.

8. The electrical connector according to claim 1, wherein in a front-rear direction, a front end surface of the lossy member is located between a front end surface of each of the signal terminals and a front end surface of the side plate.

9. The electrical connector according to claim 1, further comprising a shielding member accommodated in the insulating body, wherein:
along the vertical direction, the lossy member is located between the ground terminals and the shielding member, the lossy member comprises a first portion in contact with the shielding member and a second portion connected to the first portion, and the first portion is located between the second portion and the shielding member; and
along the left-right direction, the first portion is in contact with the side plate, and the second portion is not in contact with the side plate.

10. The electrical connector according to claim 9, wherein:
the second portion comprises a first surface and at least one second surface connected to the first surface;
along the vertical direction, a first gap exists between the first surface and at least one of the ground terminals, along the left-right direction, a second gap exists between the second surface and at least one of the ground terminals, the first gap is in communication with the second gap, and air is respectively filled in the first gap and the second gap; and
along the vertical direction, a width of the second gap becomes narrower in a direction from the second portion toward the first portion.

11. The electrical connector according to claim 1, further comprising a shielding member and at least two insulating blocks accommodated in the insulating body, wherein:
each of the insulating blocks has at least one of the signal terminals therein;
at least one of the ground terminals extends toward the lossy member to form two side plates, and the two side plates are respectively located at a left side and a right side of the lossy member and are respectively in contact with the lossy member;
viewing along a front-rear direction, the lossy member is located between the two insulating blocks;
along the vertical direction, the lossy member is located between each of the ground terminals and the shielding member, a gap exists between at least one of the ground terminals and the lossy member, and each of the insulating blocks comprises a first end in contact with the signal terminals and a second end in contact with the shielding member; and
along the left-right direction, a first distance exists between two adjacent first ends, a second distance exists between two adjacent second ends, and the first distance is greater than the second distance.

12. The electrical connector according to claim 1, further comprising a shielding member accommodated in the insulating body, wherein:
along the vertical direction, the lossy member is located between the ground terminals and the shielding member, the lossy member comprises a first portion in contact with the shielding member and a second portion connected to the first portion, and the first portion is located between the second portion and the shielding member; and
along the left-right direction, the first portion is in contact with the side plate, along the vertical direction, the second portion is in contact with the ground terminals, and a slot exists between the second portion and at least one of the ground terminals.

13. The electrical connector according to claim 1, wherein:
the insulating body is provided with an insertion plate, and the side plate is at least partially located on the insertion plate; and
each of the signal terminals comprises a signal contact section, each of the ground terminals comprises a grounding contact section, and in the vertical direction, the grounding contact section and the signal contact section are exposed on a same surface of the insertion plate, and a free end of the side plate protrudes toward the insertion plate relative to the ground terminals.
